(19) United States
(12) Patent Application Publication
(10) Pub. No.: US 2026/0342204 A1
(43) Pub. Date: Oct. 29, 2026

(54) HIGH-EFFICIENCY PHASE-SHIFT MODULATION SCHEME FOR SINGLE-STAGE AC/DC DUAL-ACTIVE-BRIDGE CONVERTER

(71) Applicant: Atieva, Inc., Newark, CA (US)

(72) Inventors: Yucheng Gao, Newark, CA (US); Dung Anh Nguyen, Newark, CA (US); Shan Chai, Newark, CA (US); Yukun Luo, Newark, CA (US)

(21) Appl. No.: 19/193,722

(22) Filed: Apr. 29, 2025

(51) Int. Cl. H02M 1/00; B60L 53/20; H02M 7/219

(52) U.S. Cl. CPC H02M 1/0058; B60L 53/20; H02M 1/0025; H02M 7/219; B60L 2210/30

(57) ABSTRACT

A single-stage AC/DC Dual Active Bridge (DAB) converter and methods of using the same are disclosed. In some embodiments, a single-stage AC/DC Dual Active Bridge (DAB) converter includes: an AC/DC DAB converter circuit, with an AC/DC DAB topology having a primary side and a secondary side and a plurality of switches, to perform power transfer between the primary side and the secondary side, where the primary side is to receive or output an AC voltage and the secondary side is to output or receive a DC voltage, respectively, based on direction of the power transfer. The single-stage AC/DC Dual Active Bridge (DAB) converter further includes a switch control coupled to control the plurality of switches of the AC/DC DAB converter circuit by varying control variables that include phase shift φ, primary side duty cycle D1 and secondary side duty cycle D2, based on instantaneous current and power, to transition the converter circuit between a plurality of modes of operation, to satisfy zero voltage switching (ZVS) criterion that includes a ZVS current threshold.

### TECHNICAL FIELD

The technical field of the present disclosure relates to AC to DC converters, more specifically AC/DC Dual-Active Bridge (DAB) converters.

### BACKGROUND

AC to DC converters strive for efficiency in power conversion, and may be used in various applications including battery charging in electric and plug-in electric hybrid vehicles. One type of AC to DC converter is the AC/DC Dual-Active Bridge (DAB) converter.

The interested reader or practitioner in the art is directed to the following reference work, for more information about DAB converters: A. Tong, L. Hang, G. Li, X. Jiang and S. Gao, “Modeling and Analysis of a Dual-Active-Bridge-Isolated Bidirectional DC/DC Converter to Minimize RMS Current With Whole Operating Range,” in IEEE Transactions on Power Electronics, vol. 33, no. 6, pp. 5302-5316, June 2018.

There is an ongoing need in the art for improvements in performance and/or efficiency in AC/DC converters, which may reduce energy costs and operating costs, for example in consumer charging of electric and plug-in electric hybrid vehicles. It is in this environment that present embodiments arise.

### SUMMARY

A single-stage AC/DC Dual Active Bridge (DAB) converter and methods of using the same are disclosed. In some embodiments, a single-stage AC/DC Dual Active Bridge (DAB) converter includes: an AC/DC DAB converter circuit, with an AC/DC DAB topology having a primary side and a secondary side and a plurality of switches, to perform power transfer between the primary side and the secondary side, where the primary side is to receive or output an AC voltage and the secondary side is to output or receive a DC voltage, respectively, based on direction of the power transfer. The single-stage AC/DC Dual Active Bridge (DAB) converter further includes a switch control coupled to control the plurality of switches of the AC/DC DAB converter circuit by varying control variables that include phase shift φ, primary side duty cycle D1 and secondary side duty cycle D2, based on instantaneous current and power, to transition the converter circuit between a plurality of modes of operation, to satisfy zero voltage switching (ZVS) criterion that includes a ZVS current threshold.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1. illustrates a single-stage AC/DC converter based on DAB topology.

FIG. 2 is an illustration of the control variables φ, D1 and D2 in a general DAB converter.

FIG. 3 illustrates regions of Schemes A, B and C, and regions of I₀.

FIG. 4 illustrates key waveforms of Schemes A, B, C.

FIGS. 5A-5B illustrate comparison of MOSFET power losses with a prior design and a present embodiment.

FIG. 6 illustrates an embodiment of a closed loop feedback system that includes a controller generating phase shift φ, and a converter.

FIG. 7 illustrates an embodiment of an AC/DC Dual Active Bridge converter in accordance with the present disclosure.

FIG. 8 is a flow diagram illustrating an embodiment of a method of operating a single-stage DC/DC DAB converter.

FIG. 9 illustrates some embodiments of a communication framework for use by an EV in communicating with an electric utility company in compliance with the electric utility interconnection requirements.

FIG. 10 is a high-level view of some embodiments of a vehicle 1000.

FIG. 11 is a high-level illustration of an exemplary computing device that can be used in accordance with the systems and methodologies disclosed herein.

### DETAILED DESCRIPTION

Described herein are various embodiments of single-stage AC/DC DAB (dual active bridge) converters with improvement in switch control, i.e., technological improvement. These embodiments may be used in onboard chargers for electric and plug-in electric hybrid vehicles, among further applications. By decreasing switching losses, through such switch control, these embodiments improve performance and efficiency, which may reduce energy costs and operation costs, for example in converting from AC grid-provided electric power to HV (high-voltage) DC to charge an electric vehicle battery.

The purpose and function of herein disclosed switch control is to improve the performance of the single-stage AC/DC DAB converter by reducing the MOSFETs switching losses. Therefore, system cost can be significantly reduced by optimizing the power losses for coolant, reducing the charging time, and increasing the discharging time during V2X operation.

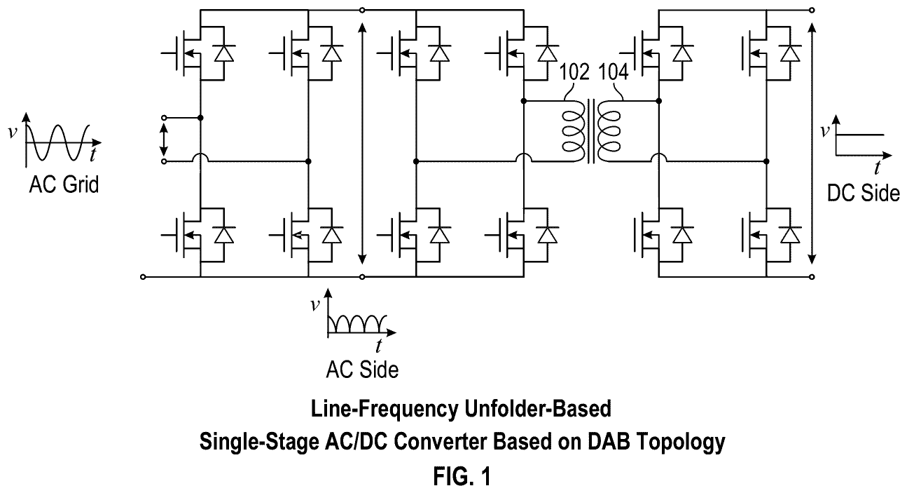

This disclosure provides an improved phase-shift modulation scheme which brings a particular benefit to the DAB converter in AC/DC power conversion application, where the bus voltage varies in a wide range and reaches to zero periodically. A DAB converter for single-stage AC/DC power conversion application can either be made with the unfolder approach, see FIG. 1(a), or the matrix converter approach, see FIG. 1(b). Presently described switch control improvements are applicable to both cases or types of AC/DC DAB converter. Each of these has switches on the primary side 102 and switches on the secondary side 104 of the converter, relating to primary side 102 and secondary side 104 of the transformer. More specifically, embodiments with switch control improvements include control of phase and duty cycles of switch operation on primary and secondary sides 102, 104 of the converter, to reduce power losses.

FIG. 1. illustrates a single-stage AC/DC converter based on DAB topology. This is shown in two cases or types. FIG. 1(a) illustrates the line-frequency unfolder-based single-stage AC/DC DAB converter. FIG. 1(b) illustrates the matrix converter-based single-stage AC/DC DAB converter. Older designs were two-stage, and had a first stage with AC to DC conversion, and a second stage with DC to DC isolation. These newer designs combine AC to DC conversion with isolation to a single-stage.

Three core concepts in some embodiments are:
1) utilize all the three phase-shift control variables available in the DAB converter to minimize the power device switching losses by maximizing the range of voltage-switching (ZVS), while keeping the power device conduction losses as low as possible; and
2) prioritize the satisfaction of ZVS for the high-voltage devices when the ZVS condition needs to be compromised; and
3) avoid the complexity of frequency modulation as well as the need of extra magnetic elements.

As a result of power losses reduction, some embodiments enable further size reduction of the power MOSFETs (e.g., switches), leading to a cost reduction of power semiconductors by approximately 12% in a typical 11.5 kW SiC-based onboard charger (OBC) design which has three AC/DC converter modules, for example. Embodiments may also reduce the need of active cooling during low-power operation of OBC (including vehicle-to-load application) which brings down unnecessary power consumption and improves overall energy utilization efficiency.

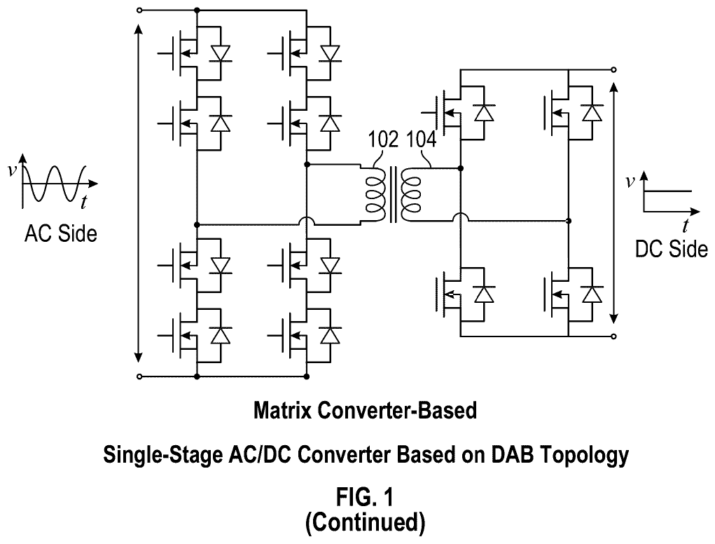

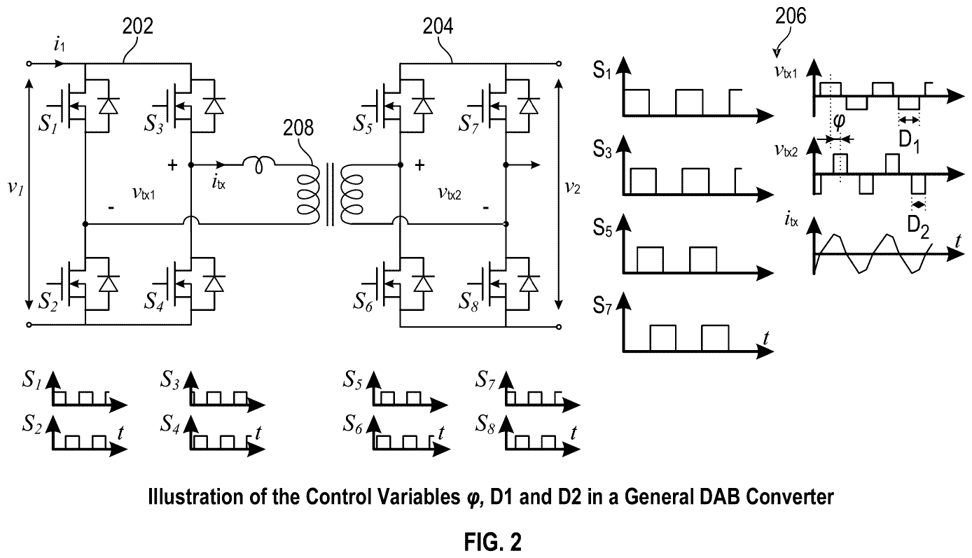

FIG. 2. is an illustration of the control variables φ, D1 and D2 in a general DAB converter. The basic circuit topology of the DAB converter is illustrated on the left in FIG. 2, and the control variables 206 of the DAB converter are illustrated on the right in FIG. 2. The master phase shift φ is defined as the fundamental-frequency phase shift between the voltages of the two sides (i.e., primary side 202 and secondary side 204 of the converter), ranging from −0.25 to 0.25, and the duty cycles D1 and D2 are defined as the ratio of the non-negative voltage period to the switching period respectively for the primary side 202 and the secondary side 204, ranging from 0% to 100%.

Example switching signals for switches S1, S3 (primary side 202), S5 and S7 (secondary side 204) are illustrated, with associated transformer voltages and transformer current (primary side 202). In some embodiments, a switching controller implements phase shift in the switching signals across the legs of the converter, and phase shift in the switching signals across primary and secondary sides of the converter. For example, there is a phase shift from the switching signal for switch S1 (e.g., in leg 1, primary side 202 of the converter) to the switching signal for switch S3 (e.g., in leg 2 of the converter), a phase shift from the switching signal for switch S3 (e.g., leg 2, primary side 202 of the converter) to the switching signal for switch S5 (e.g., in leg 3, secondary side 204 of the converter), and a phase shift from the switching signal for switch S5 (e.g., in leg 3, secondary side 204 of the converter) to the switching signal for switch S7 (e.g., in leg 4, secondary side 204 of the converter). These phase shifts between the legs create a three-step voltage function, and corresponding step-wise current function, seen to the far right in FIG. 2. The phase shift φ between the primary side 202 and secondary side 204 of the converter defines the power transfer. Generally, phase shift φ depends on power and voltage. A positive value of phase shift φ is for left to right power transfer, i.e., AC to DC, a negative value of phase shift φ is for right to left power transfer, i.e., DC to AC, e.g., in bidirectional power transfer embodiments. This is understood as leading phase shift applying to charging, and lagging phase shift applying to discharging, e.g. a battery connected to the secondary side 204.

Firstly, a specific case is discussed in detail, which is when the primary voltage v1 is lower than the secondary voltage v2, and the power flows from the primary side 202 to the secondary side 204. The other cases will be discussed later, which can be extended based on this specific case.

Principally, simply tuning the master phase shift would be able to achieve the desired power flow. However, with the help of variable D1 and D2, the switching waveform can be further tuned which enables substantial reduction in power device switching and conduction loss. For the power MOSFETs commonly used as switches in the AC/DC power conversion applications, achieving zero-voltage-switching (ZVS) is the most effective way of switching loss reduction. ZVS is essentially achieved when the devices are turned off at a sufficiently large negative current to completely discharge the MOSFET parasitic capacitance before it turns on.

In this disclosure, since the tank inductance is considered as a constant value, the ZVS criterion is simplified into a single current value threshold evaluated at the instant of the switching transition, which is denoted as I_{zvs1} for the primary devices, and I_{zvs2} for the secondary devices. To fully achieve ZVS, the transformer 208 current it should be:
Lower or equal to −I_{zvs1}, when vₜₓ₁ toggles from negative to zero, or zero to positive
Higher or equal to +I_{zvs1}, when vₜₓ₁ toggles from positive to zero, or zero to negative
Higher or equal to +I_{zvs2}, when vₜₓ₂ toggles from negative to zero, or zero to positive
Lower or equal to −I_{zvs2}, when vₜₓ₂ toggles from positive to zero, or zero to negative

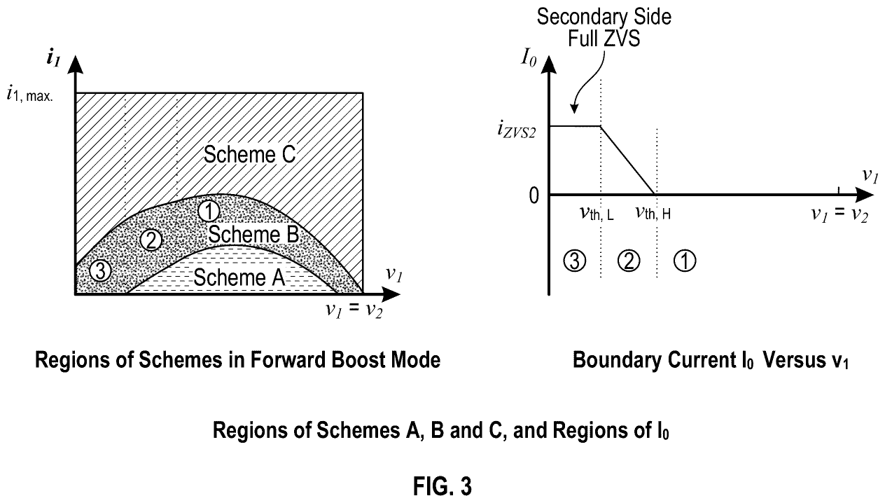

To maximize the ZVS range and minimize the transformer RMS current, based on the instantaneous voltage and power (e.g., as shown in FIG. 3(a)), the converter is selected to operate in one of the following three schemes, for example named Scheme A, Scheme B and Scheme C, as described below.

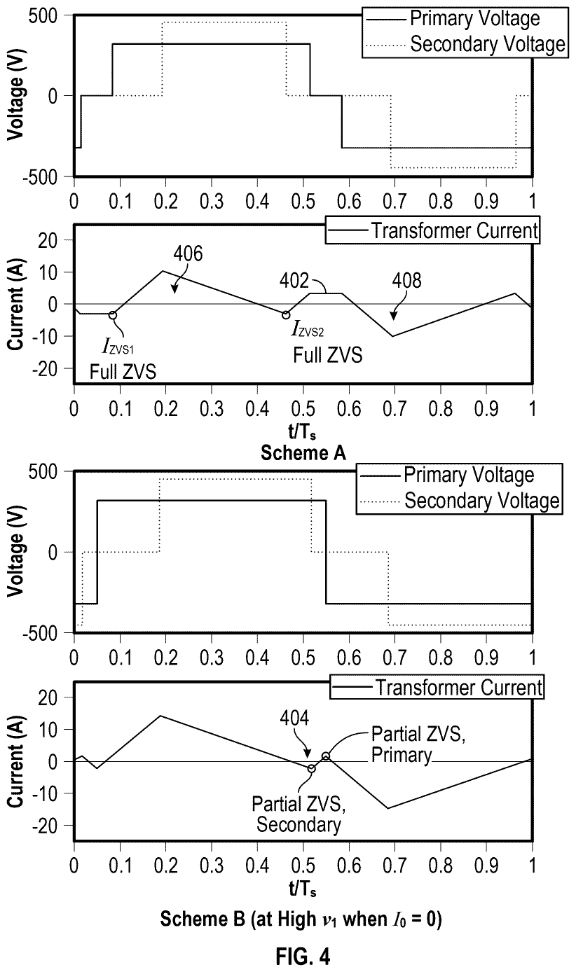

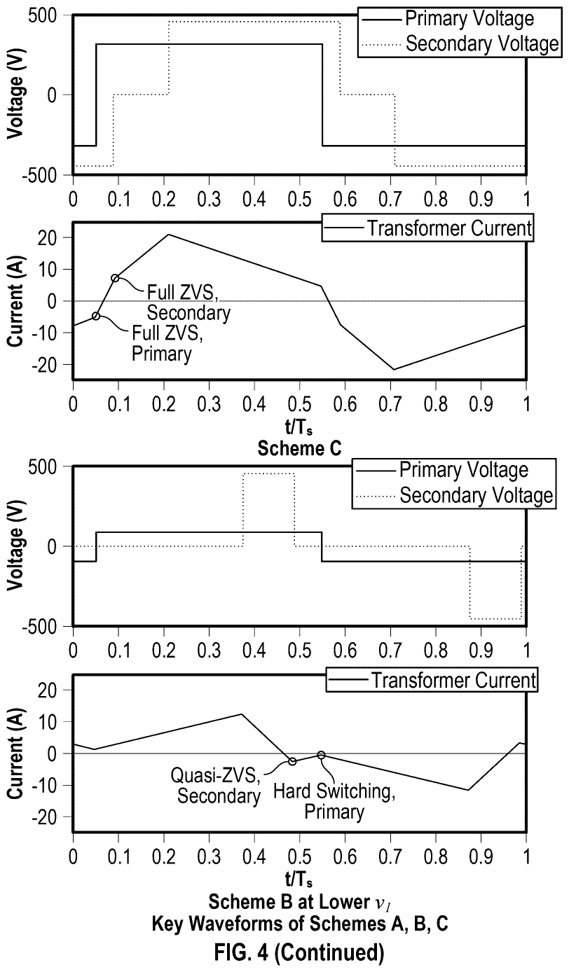

FIG. 3. illustrates regions of Schemes A, B and C, and regions of I₀. Regions of schemes in forward boost mode are shown in FIG. 3(a), and boundary current I₀ versus voltage v₁ is shown in FIG. 3(b). In various embodiments, the converter switches among these operation modes depending on power level, to optimize performance at each power point. Depending on voltage and current, the embodiments create smooth transitions between Schemes A, B, C. More specifically, in various embodiments, the transition between schemes A, B, C depends on a zero voltage switching condition. Typical voltage switching waveforms are shown in FIG. 4, for each condition depicted in FIG. 3.

FIG. 4. illustrates key waveforms of Schemes A, B, C. Scheme A waveforms are shown in FIG. 4(a). Scheme B waveforms for higher v₁, when I₀=0 are shown in FIG. 4(b). Scheme C waveforms are shown in FIG. 4(c). Scheme B waveforms for lower v₁ are shown in FIG. 4(d).

One insight relating FIG. 4 to FIG. 3 is that the flat region 402 in the current, in Scheme A (see FIG. 4(a)) goes to zero (e.g., a point, not a line segment) as power increases, and the system transitions from Scheme A to Scheme B (see FIG. 4(b). Similarly, when the sloped flat region 404 in the current, in Scheme B (see FIG. 4(b)) goes to zero (e.g., a point, not a line segment) as power increases, the system transitions from Scheme B to Scheme C (see FIG. 4(c). These correspond to partial or full zero voltage switching conditions, as denoted in the drawing.

Another insight in FIG. 4 is that large positive area 406 or large negative area 408 under the curve for current (relative to zero horizontal line) defines a region used for power transfer, and small area under the curve for current (relative to zero horizontal line) may define a region that can be used for zero voltage switching conditions.

Scheme A: At low-power, high-voltage condition, the converter is modulated to keep the transformer current in a form similar to the discontinuous conduction mode (DCM) when the current is flat, but the value is non-zero in order to achieve ZVS. A typical waveform is shown in FIG. 4(a). The primary devices are switched exactly at the threshold I_{zvs1}, while the secondary devices are switched at I_{zvs2} in one instant, and at peak current Iₚₖ (e.g., transformer maximum or peak current) at the other instant.

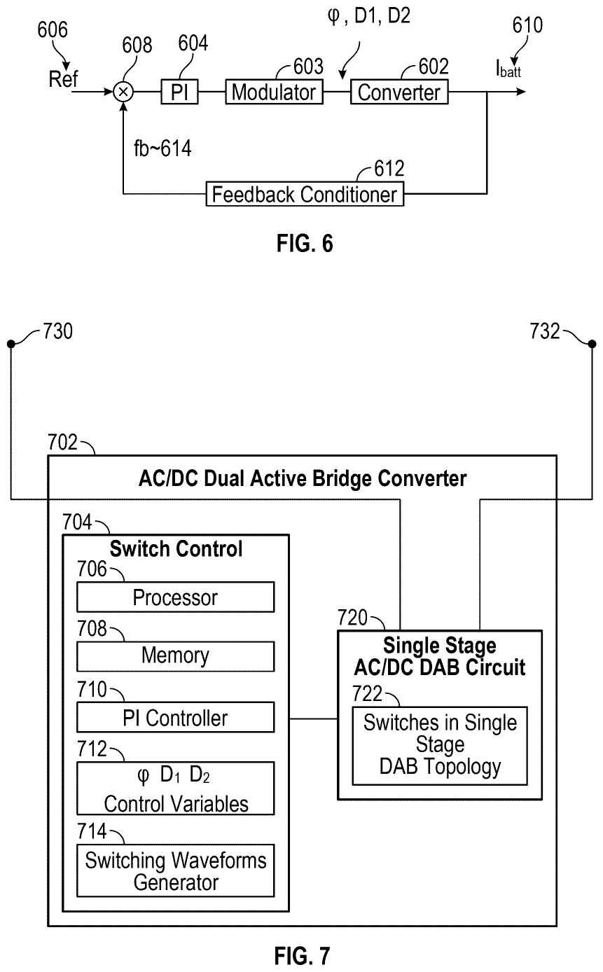

When the master phase shift φ is given by the controller, the duty cycles D₁ and D₂ can be calculated based on the following equations, where v₂ is the battery voltage (i.e., secondary side), v₁ is the input voltage (i.e., primary side), and phase shift φ is controlled by a controller (see FIG. 6):

$${D}_{2} = 2 ( {I}_{zvs 2} + {I}_{pk} ) \frac{{L}_{r} {f}_{s}}{{v}_{2} - {v}_{1}}$$

$${D}_{1} = {D}_{2} + 4 φ + 4 ( {I}_{zvs 1} + {I}_{zvs 2} ) \frac{{L}_{r} {f}_{s}}{{v}_{1}}$$

$$where$$

$${I}_{pk} = {I}_{zvs 2} + \frac{2 φ}{{f}_{s} {L}_{r}} {v}_{1}$$

The boundary condition of this scheme is reached when D₁ reaches 100% and the duration of the flat current is zero. The corresponding phase shift φ is

$${φ}_{bound , AB} = [ \frac{1}{4} - \frac{{I}_{zvs 1} {L}_{r} {f}_{s}}{{v}_{1}} - \frac{{I}_{zvs 2} {L}_{r} {f}_{s}}{{v}_{1}} - \frac{{I}_{zvs 1} {L}_{r} {f}_{s}}{{v}_{2} - {v}_{1}} ] \frac{{v}_{2} - {v}_{1}}{{v}_{2}}$$

Note that the calculated φ_{bound,AB} could be a negative value. In such case, the Scheme A is not available at the given combination of voltage.

Scheme B: This scheme is to support a smooth transition between Schemes A and C in the practical converter operation. However, by doing so, it is not possible to achieve full ZVS in all the devices, and the ZVS condition is compromised, as shown in FIG. 4(b). The worst-case is reached when the rising edge of vₜₓ₁ and vₜₓ₂ overlaps, and the transformer current at this point is denoted as I₀. One of the important concepts in various embodiments is that, based on the voltage and the device properties, I₀ can be tuned to minimize the overall loss of the system. If same devices are used on both sides of the converter and the voltages are similar, then some embodiments optimize by keeping I₀=0, so that the degree of ZVS compromise is even on the two sides. However, if the primary side voltage v₁ becomes substantially lower than the secondary voltage v₂, then I₀ can be increased to a positive value, to further reduce the switching loss on the secondary side, as shown in FIG. 3(b):

$${I}_{0} = \{ \begin{matrix}0 & {v}_{1} \geq {v}_{th , H} \\ \frac{{v}_{th , H} - {v}_{1}}{{v}_{th , H} - {v}_{th , L}} {I}_{zvs 2} & {v}_{th , L} < {v}_{1} < {v}_{th , H} \\ {I}_{zvs 2} & {v}_{1} \leq {v}_{th , L}\end{matrix}$$

Where v_{th,H} and v_{th,L} are selected based on device hard-switching characteristics.

In an example, the v_{th,H} and v_{th,L} are selected as 200V and 100V respectively. A typical waveform set, e.g., primary voltage, secondary voltage and transformer current, for when v₁ is low in Scheme B is shown in FIG. 4(d).

The primary devices will have lower loss even at a hard-switching condition, because of the low drain-to-source voltage. The boundary condition of this scheme (i.e., Scheme B) is

$${φ}_{bound , BC} = \frac{{v}_{2} - {v}_{1}}{4 {v}_{2}} + \frac{{I}_{0} {f}_{s} {L}_{r}}{{v}_{2}}$$

When in Scheme B, the master phase shift φ is between Abound, A B and Abound, BC. The primary duty D1 will be consistently 100%, while the secondary side D2 is set to change linearly with φ, i.e.,

$${D}_{2} = {D}_{2 , bound , AB} + ( {D}_{2 , bound , BC} - {D}_{2 , bound , AB} ) \frac{φ - {φ}_{bound , AB}}{{φ}_{bound , BC} - {φ}_{bound , AB}}$$

where D_{2,bound,AB} and D_{2,bound,BC} are respectively the value of D2 when the master phase shift φ=φ_{bound,AB} and φ=φ_{bound, BC}.

Scheme C: At high-power condition, the converter is modulated to keep the transformer current in continuous conduction mode (CCM) with negative switching current, as shown in FIG. 4(c). Except in the small region close to the boundary of Scheme B, the zero-voltage-switching can be achieved in all the switches. The exact duty cycle D2 is selected to change linearly with the commanded master phase shift φ. This is close to an optimal solution to minimize the transformer RMS current, which directly relates to the conduction loss, while minimizing the calculation complexity. In one embodiment,

$${D}_{2} = {D}_{2 , bound , BC} + ( 100 \% - {D}_{2 , bound , BC} ) \frac{φ - {φ}_{bound , BC}}{0.25 - {φ}_{bound , BC}}$$

In forward boost mode, when the instantaneous ac voltage v_{ac} is lower than the dc output voltage v_{dc}, and the instantaneous power is positive (φ>0), the scheme can be directly employed by having v₁=v_{ac} and v₂=v_{dc}. Furthermore, this scheme can also be extended into “buck mode” (when the ac side instantaneous voltage is higher than the dc side bus voltage) as well as the “reverse mode” (when the power flows from the dc side to the ac side, i.e. for embodiments with bidirectional current flow such as battery discharge to AC side) based on the same principle but with a conversion as follows:

Reverse boost mode (when v_{ac}<v_{dc} and power <0): This mode can be treated as equivalent to time goes in the negative direction. The calculation can be done by adding a negative sign for φ and keeping the same duty cycles.

Buck mode (when the instantaneous v_{ac}>v_{dc}): This mode can be treated as a boost mode from the dc side to the ac side. Therefore, the calculation can be made by swapping v₁ and v₂ (having v₁=v_{dc} and v₂=v_{ac}), and φ will be a positive number when taking the ac side as the basis.

Reverse buck mode (when v_{ac}>v_{dc} and power <0): Similar to buck mode, but ø will be a negative number.

An implementation example made in Matlab language is shown in Table 1.

TABLE 1
Mathematical logic of converting buck mode/reverse mode into forward boost mode

| Forward boost mode (phi >= 0, Vac <= Vdc) | Forward buck mode (phi >= 0, Vpri > Vsec) |
|---|---|
| V1 = Vac; | V1 = Vdc; |
| V2 = Vdc; | V2 = Vac; |
| [D1, D2] = fn_forward_boost_mode(V1, V2, phi); | [D1, D2] = fn_forward_boost_mode(V1, V2, phi); |
| Dac = D1; | Dac = D2; |
| Ddc = D2; | Ddc= D1; |
| Reverse boost mode (phi < 0, Vpri <= Vsec) | Reverse buck mode (phi < 0, Vpri > Vsec) |
| V1 = Vac; | V1 = Vdc; |
| V2 = Vdc; | V2 = Vac; |
| [D1, D2] = fn_forward_boost_mode(V1, V2, −phi); | [D1, D2] = fn_forward_boost_mode(V1, V2, −phi); |
| Dac = D1; | Dac = D2; |
| Ddc = D2; | Ddc = D1; |

```
The main modulation function
[D1, D2] = fn_forward_boost_mode(V1, V2, phi)
  % Circuit Parameters
  Lr = 15e−6;
  fs = 125e3;
  Izvs1 = 3;
  Izvs2 = 3;
  Vth_H = 200;
  Vth_L = 100;
  % Compromised switching current at Scheme B/C boundary
  I0 = (Vth_H−V1)/(Vth_H−Vth_L)*Izvs2;
  I0 = min(max(I0, 0), Izvs2);
  % Boundary phases
  phi_AB = (¼ − Izvs1*Lr*fs/V1 − Izvs2*Lr*fs/V1 − Izvs1*Lr*fs/(V2−V1))*(V2−V1)/V2;
  phi_BC = (V2−V1)/(4*V2) + I0*fs*Lr/(V2);
  % Scheme A
  if (phi <= phi_AB)
    Ipk = Izvs2 + 2*phi*V1/(fs*Lr);
    D2 = 2*(Izvs2+Ipk)*Lr*fs/(V2−V1);
    D1 = D2 + 4*phi + 4*(Izvs1+Izvs2)*Lr*fs/V1;
  % Scheme B
  elseif (phi < phi_BC)
    D1 = 1;
    D2_AB = 2*(Izvs2 + (Izvs2 + 2*phi_AB*V1/(fs*Lr)) )*Lr*fs/(V2−V1);
    D2_BC = 1 − 4*phi_BC;
    D2 = D2_AB + (D2_BC−D2_AB) * (phi − phi_AB)/(phi_BC − phi_AB);
  % Scheme C
  else
    D1 = 1;
    D2_BC = 1 − 4*phi_BC;
    D2 = D2_BC + (1−D2_BC) * (phi − phi_BC)/(0.25 − phi_BC);
  end
end
```

The above implementation example can be executed in a simulator, to simulate a converter embodiment with a mean modulation function, forward boost mode, forward buck mode, reverse boost mode in reverse buck mode in accordance with the teachings herein. Further, the above implementation example can be translated, ported or otherwise adapted into software or firmware for execution on a processor, for example in a controller, for a converter embodiment. See also further embodiments described with reference to FIG. 6 and FIG. 7, for which the above implementation example may be applicable.

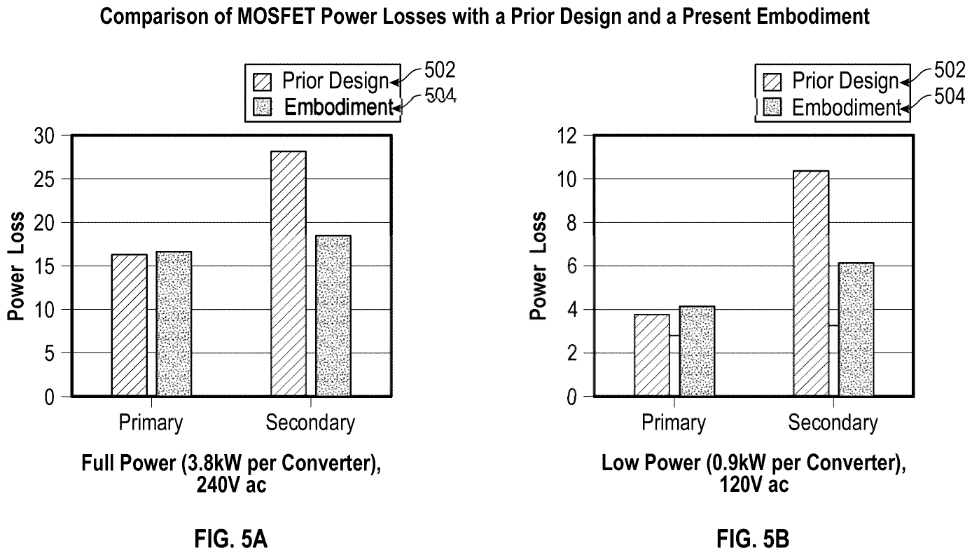

FIGS. 5A-5B illustrate comparison of MOSFET power losses with a prior design and a present embodiment. The advantages of the embodiments described herein, in terms of power device loss reduction are quantitively evaluated in the following design example of an electric vehicle onboard charger. Comparison for power losses is shown at 240 V AC operation in FIG. 5A and at 120 V AC operation in FIG. 5B. The switching circuit design for the comparison uses Rohm SCT4045DTW power MOSFETs for the primary (ac) side and Rohm SCT4062KTW for the secondary (dc) side. The transformer has a turn ratio of 1:1.8 and the leakage inductance is 45 uH seen from the secondary side. The nominal switching frequency is 125 kHz. The loss figures are calculated at the operating point of 925V dc output, which is the worst-case scenario in terms of MOSFET power losses.

As shown in FIG. 5A, one present embodiment with switch control improvements brings down the power losses of the secondary side MOSFETs by 34%. In other words, in a cost-driven design, the MOSFET can be downgraded by 12% cost in a 11.5 kW onboard charger design comprised of three converter modules. Similar benefits are shown in FIG. 5B.

Furthermore, in low power mode, the example present embodiment reduces the worst-case MOSFET losses by 41%. As a result, the system no longer needs active cooling running from the chiller when operating in the low-power mode, which substantially improves the system-level energy utilization efficiency.

FIG. 6 illustrates an embodiment of a closed loop feedback system that includes a controller 604 generating phase shift φ, and a converter 602. A variable reference 606, labeled “ref” is one input to a summer 608 or summing junction, the other input being a variable feedback 614, labeled “fb”. To make a closed loop, output of the summer 608 is input to a controller 604, in this embodiment a PI (proportional integral) controller (a.k.a. PIC) that generates the phase shift φ, for example by scaling a time integral of the input to the controller 604 (or, equivalently, integrating the scaled difference input of the PI controller). Output of the controller 604, i.e., the phase shift φ, is input to modulator 603, which performs the modulation described herein. The output of modulator 603 is input to the converter 602, which may include switches and switch control specifically implementing an AC/DC DAB converter architecture as discussed above. From the phase shift, duty cycle variables D₁ and D₂ are determined in accordance with the above principles and techniques (e.g., through a processor, not shown, could be part of the controller 604 and/or part of the converter 602). And, the three variables, phase shift, duty cycle D1 and duty cycle D2, are used to drive switch controls, e.g., generate switch control signals applied to MOSFET gate terminals. This could be done through a processor, controller, software, firmware, hardware, or combinations thereof. Output of the converter 602 is battery current 610, labeled I_{batt}, which charges a battery and also connects to feedback conditioner 612, to provide feedback 614 in the closed-loop. For example feedback conditioner 612 could include a sensor, processor translation of generated or sampled parameter, digital conversion of an analog value, averaging or noise reduction, or other conditioning as appropriate to a feedback loop and signal thereof. The closed-loop feedback system matches output battery current 610 to requested value, reference 606, by generating a difference value through the summer 608, integrating the difference value or a scaled or proportional value, and deriving control variables φ, D1 and D2, for switch control signals of the converter 602. With switch controls (e.g., switching waveforms, signals) derived from the phase shift φ and duty cycle variables D1 and D2, the converter 602 performs power transfer, matching output battery current 610 to the reference 606.

FIG. 7 illustrates an embodiment of an AC/DC Dual Active Bridge converter 702 in accordance with the present disclosure. The converter includes a switch control 704 coupled to a single-stage AC/DC DAB circuit 720. In the single-stage AC/DC DAB circuit 720, switches 722 are arranged in a single-stage DAB topology, such as the examples previously discussed, other known topologies, or may be in a further, readily derived, related topology as a variation. To drive the switches 722, the switch control 704 generates switching waveforms, i.e., switching signals that each have a waveform shape. Switch control 704 includes a processor 706, memory 708, and further modules which may be implemented in software executing on the processor 706, firmware, hardware or combinations thereof. A PI controller 710 is included, and operates or functions similarly to the controller 604 described above with reference to FIG. 6. Control variables 712, e.g., phase shift φ, duty cycle D1 and duty cycle D2, are generated, for example by suitable programming of the processor 706. A switching waveforms generator 714 generates the switching waveforms for the switches 722, based on the control variables 712. That is, the switching waveforms are generated to have phase shift φ, duty cycle D1 and duty cycle D2 associated to the corresponding switches, legs and sides (primary and secondary) of the single-stage AC/DC DAB circuit 720. For example, processor calculations and software or hardware timers could be used for generating switching waveforms. Operated with such switching waveforms, the switches 722 in single-stage DAB topology perform power transfer from the primary side terminal 730, to the secondary side terminal 732, or vice versa (in bidirectional designs).

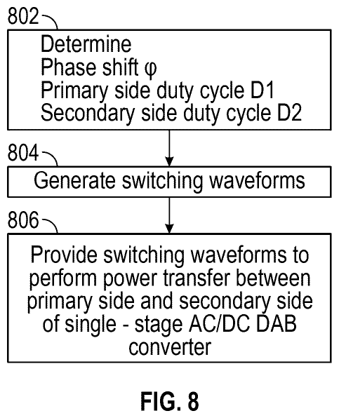

FIG. 8 is a flow diagram illustrating an embodiment of a method of operating a single-stage DC/DC DAB converter. The method can be practiced on or by embodiments described herein, and variants thereof. The method can be practiced by a processor, for example a processor in a controller coupled to a single-stage AC/DC DAB converter circuit, or in a single-stage DC/DC DAB converter.

Referring to FIG. 8, the method includes determining a phase shift φ, primary side duty cycle D1 and secondary side duty cycle D2 (action 802). These are for a single-stage AC/DC DAB converter, which has an AC/DC DAB converter circuit with switches arranged in an AC/DC DAB topology, and a switch control coupled to the AC/DC DAB converter circuit.

The method also includes generating switching waveforms based on the a phase shift φ, primary side duty cycle D1 and secondary side duty cycle D2 (action 804). That is, these switching waveforms have the phase shift φ, the primary side duty cycle D1 and the secondary side duty cycle D2, associated to corresponding switches, legs, primary side and secondary side of the AC/DC DAB converter circuit.

The method also includes performing a power transfer from the primary side between the secondary side of the single-stage DC/DC DAB converter, using the switching waveforms (action 806). The power transfer has reduced switching power losses through varying the phase shift φ, the duty cycle D1 and the duty cycle D2 to increase range of full or partial zero voltage switching (ZVS).

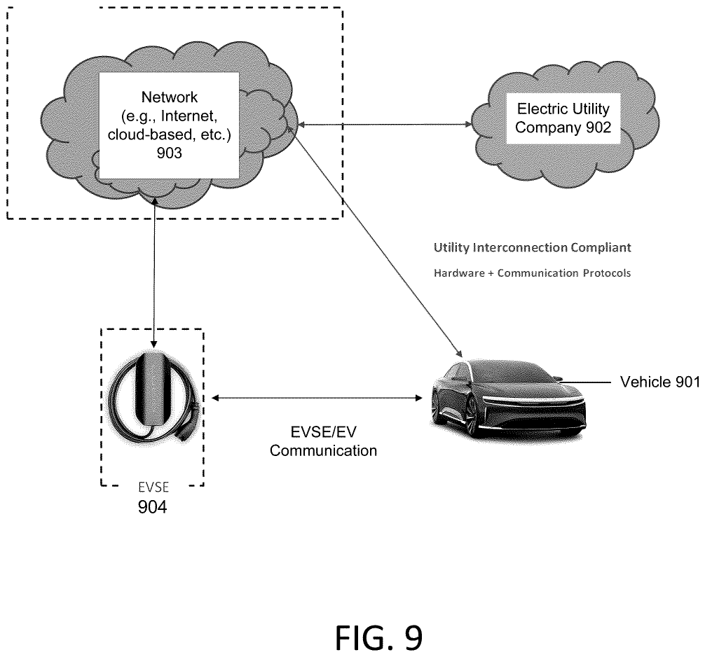

As set forth herein, in some embodiments, the single-stage DC/DC DAB converter transfers power from DC to AC, such as, for example, in the case of transferring power from the vehicle to the grid. FIG. 9 illustrates some embodiments of a communication framework for an electric vehicle (EV) to communicate with an electric utility company in compliance with the electric utility interconnection requirements related to vehicle-to-grid energy transfers.

Referring to FIG. 9, a mobile vehicle 901 and an electric utility 902 are communicably coupled to a network 903. In some embodiments, the communications between mobile vehicle 901 and electric utility company 902 are sent through network 903. Network 903 can include a cloud-based communication network (e.g., cloud-based communications).

In some embodiments, mobile vehicle 901 comprises an EV. In some embodiments, mobile vehicle 901 includes energy storage (e.g., one or more batteries, a battery pack, etc.), a charging port electrically coupled to the energy storage to transfer power to and from the energy storage, an inverter to generate voltage to be sent into an electrical power grid, on-board communication hardware and protocols, and one or more processors. The processor(s) exchange communications with electric utility company 902, using the communication hardware and according to interoperability requirements of electric utility company 902. Because the communications meet the interoperability requirements of electric utility company 902, the communication hardware and protocols of mobile vehicle 901 are considered utility interconnection compliant. In some embodiments, the communications related to the interoperability requirements occur between the communication hardware and the electric utility company without going through the charging port.

In some embodiments, the communications with electric utility company 902 and mobile vehicle 901 are related to discharging voltage from the EV's energy storage to the electrical power grid. That is, mobile vehicle 901 operates as an energy storage system that has vehicle-to-grid capability to discharge energy into the electrical power grid (i.e., grid discharge capability).

In some embodiments, mobile vehicle 901 has an inverter to support the vehicle-to-grid capability to discharge energy into the electrical power grid. As mobile vehicle 901 moves to different portions of the electrical power grid, its inverter becomes a mobile inverter that is able to provide power to those different portions of the grid. In some embodiments, the communications with electric utility company 902 include inverter settings associated with the inverter of mobile vehicle 901. The inverter settings can be site specific based on the portion of the electrical grid to which mobile vehicle 901 is connected. In some embodiments, the communications with electric utility company 902 meet utility interconnection requirements for stationary inverter based generation via the IEEE 1547-2018 Standard. In some embodiments, the inverter settings for the stationary inverter are the optimal settings as per the IEEE 1547-2018 Standard. In some embodiments, the inverter settings are given during an interconnection approval process, but can change during operation. Such a change can be due to an interconnection agreement.

In some embodiments, the communication hardware and protocols used by mobile vehicle 901 to meet the interconnection requirements of the electric utility comprise a communication gateway and a communication physical layer. In some embodiments, the communication physical layer comprises an Ethernet communication system layer with an Ethernet interface and communications related to the interoperability requirements occur via the Ethernet interface. In some embodiments, the Ethernet communication system comprises an Ethernet Ring that transfers communications related to vehicle-to-grid operations according to the interoperability requirements of the electric utility company as well as communications related to other non-vehicle-to-grid related communications of the EV. In some embodiments, the non-vehicle-to-grid related communications comprise communications related to one or more subsystems of mobile vehicle 901, such as, for example, a driver-assistance system of mobile vehicle 901.

In some embodiments, mobile vehicle 901 is charged using a charger, such as by EVSE 904. In some embodiments, the energy storage (e.g., batteries, etc.) of mobile device 901 can be charged when EVSE 904 is plugged into, or otherwise electrically connected to, the charging port of mobile vehicle 901. In some embodiments, when EVSE 904 is plugged into, or otherwise electrically connected to, the charging port of mobile device 901, EV communications with the charger occur. These communications can determine the amount of power a charger can provide and can includes requests for an amount of power to be provided to mobile vehicle 901. In some embodiments, these communications occur over a HomePlug Green-PHY Power Line Carrier. Note that any communications between EVSE 904 and mobile vehicle 901 are not related to the vehicle-to-grid discharging power (current) from the EV's energy storage to the electrical power grid and they are not associated with the interoperability requirements of the electric utility company related to that capability.

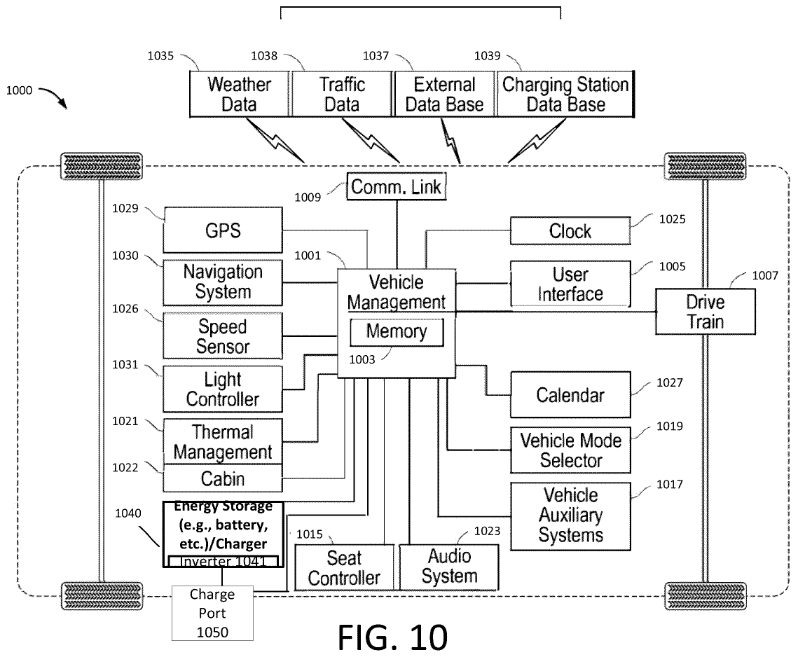

FIG. 10 is a high-level view of some embodiments of a vehicle 1000. Vehicle 1000 can be an electric vehicle (EV), a vehicle utilizing an internal combustion engine (ICE), or a hybrid vehicle, where a hybrid vehicle utilizes multiple sources of propulsion including an electric drive system. Vehicle 1000 includes a vehicle on-board system controller 1001, also referred to herein as a vehicle management system, which is comprised of one or more processors (e.g., a central processing unit (CPU)). System controller 1001 also includes memory 1003, with memory 1003 being comprised of EPROM, EEPROM, flash memory, RAM, solid state drive, hard disk drive, or any other type of memory or combination of memory types.

In some embodiments, vehicle 1000 includes one or more internal networks by which system controller 1001 interfaces and communicates with one or more internal subsystems of vehicle 1000. System controller 1001 can also use the one or more internal networks to transfer communications to and from external locations. In some embodiments, the one or more internal networks can be communicably coupled to one or more networks through a network interface. The network interface can provide for wired and/or wireless communication. When used in a local area networking environment (or a wide area networking environment), the network interface can include an Ethernet interface and the one or more internal networks includes an Ethernet communication network (e.g., an Ethernet Ring, etc.) with an Ethernet Port. Other possible embodiments use other communication devices. For example, in some embodiments vehicle 1000 includes a modem for communicating across an internal network and/or with an external network.

In some embodiments, vehicle 1000 includes a charging port 1050 and one or more batteries (e.g., battery pack, etc.)/battery charger as an energy storage system 1040 that provides power to portions of vehicle 1000. The charging port 1050 is used for providing voltage to vehicle 1000 for charging the energy storage system 1040 (e.g., charging batteries of batteries/charger by the use of, for example, an EVSE or other power source in a manner well-known in the art. The charging port 1050 can be used to transfer power from a battery of the energy storage system 1040 to an external location as part of a vehicle-to-grid power transfer. In some embodiments, charging port 1050 includes a communication path for communications between the system controller 1001 and the locations external to vehicle 1000 such as, for example, the power source providing power (voltage) to vehicle 1000 for charging batteries of the energy storage system 1040 and a utility distributed energy resource management system (DERMS) or an electric utility company and its facilities.

In some embodiments, energy storage system 1040 includes an inverter that generates voltage for transfer to an electric power grid. In some embodiments, the inverter converts DC voltage to AC voltage for transfer to the electric power grid. In some embodiments, the same inverter (or a separate invertor) converts DC voltage to AC voltage for charging a battery of the energy storage system 1040 or can provide DC to AC voltage conversion when providing power to an electrical power grid as part of a vehicle-to-grid operation.

In some embodiments, vehicle 900 includes a user interface 1005 is coupled to vehicle management system 1001. Interface 1005 allows the driver, or a passenger, to interact with the vehicle management system, for example inputting data into the navigation system 1030, altering the heating, ventilation and air conditioning (HVAC) system via the thermal management system 1021, controlling the vehicle's entertainment system (e.g., radio, CD/DVD player, etc.), adjusting vehicle settings (e.g., seat positions, light controls, etc.), and/or otherwise altering the functionality of vehicle 1000. In some embodiments, user interface 1005 also includes means for the vehicle management system to provide information to the driver and/or passenger, information such as a navigation map or driving instructions (e.g., via the navigation system 1030 and GPS system 1029) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 1026), current HVAC settings such as cabin temperature and/or fan settings, etc.) via the thermal management system 1021. Interface 1005 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 1000 can also include other features like an internal clock 1025 and a calendar 1027.

In some embodiments, user interface 1005 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 1005 includes a graphical display, controller 1001 may also include a graphical processing unit (GPU), with the GPU being either separate from or contained on the same chip set as the processor.

Vehicle 1000 also includes a drive train 1007 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. System controller 1001 monitors various vehicle functions that the driver may use to enhance the fit of the car to their own physical characteristics, such as seat position (e.g., seat position, seat height, seatback incline, lumbar support, seat cushion angle and seat cushion length) using seat controller 1015 and steering wheel position using an auxiliary vehicle system controller 1017. In some embodiments, system controller 1001 also can monitor a driving mode selector 1019 which is used to control performance characteristics of the vehicle (e.g., economy, sport, normal). In some embodiments, system controller 1001 can also monitor suspension characteristics using auxiliary vehicle system 1017, assuming that the suspension is user adjustable. In some embodiments, system controller 1001 also monitors those aspects of the vehicle which are often varied by the user in order to match his or her environmental preferences for the cabin 1022, for example setting the thermostat temperature or the recirculation controls of the thermal management system 1021 that uses an HVAC controller, and/or setting the radio station/volume level of the audio system using controller 1023, and/or setting the lights, either internal lighting or external lighting, using light controller 1031. Also, besides using user-input and on-board sensors, system controller 1001 can also use data received from an external on-line source that is coupled to the controller via communication link 1009 (using, for example, GSM, EDGE, UMTS, CDMA, DECT, WiFi, WiMax, etc.). For example, in some embodiments, system controller 1001 can receive weather information using an on-line weather service 1035 or an on-line data base 1037, traffic data 1038 for traffic conditions for the navigation system 1030, charging station locations from a charging station database 1039, etc. In some embodiments, communication link 1009 comprises an Ethernet communication link with an Ethernet Port for external communications.

The system controller 1001 can transfer information with the components described above over one or more internal networks, such as those, for example, described above. In some embodiments, the system controller 1001 is communicably coupled to one or more of these components via an Ethernet communication network (e.g., an Ethernet Ring, etc.). The Ethernet communication network can be used to transfer other data such as data related to, but not limited to, one or more of a driver-assistance system, telematics, over-the-air updates, etc.

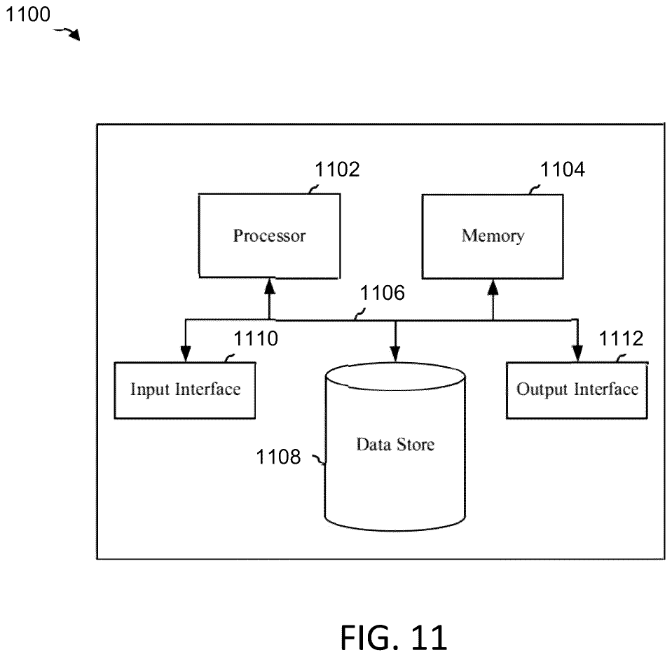

FIG. 11 is a high-level illustration of an exemplary computing device 1100 that can be used in accordance with the systems and methodologies disclosed herein. For instance, the computing device 1100 may be or include the vehicle 1000 of FIG. 10. The computing device 1100 includes at least one processor 1102 that executes instructions that are stored in a memory 1104. The instructions may be, for instance, instructions for implementing functionality described as being carried out by one or more modules or instructions for implementing one or more of the methods described above. The processor 1102 may access the memory 1104 by way of a system bus 1106.

The computing device 1100 additionally includes a data store 1108 that is accessible by the processor 1102 by way of the system bus 1106. The data store 1108 may include executable instructions and the like. The computing device 1100 also includes an input interface 1110 that allows external devices to communicate with the computing device 1100. For instance, the input interface 1110 may be used to receive instructions from an external computing device, from a user, etc. The computing device 1100 also includes an output interface 1112 that interfaces the computing device 1100 with one or more external devices. In some embodiment, the input interface 1110 and the output interface 1112 can be used to communicate to an electric utility company (e.g., a utility distributed energy resource management system (DERMS) or server, etc.). These communications can relate to vehicle-to-grid operations and/or standards as described above. In some embodiment, the input interface 1110 and the output interface 1112 are part of, or communicably coupled to, an Ethernet port of an Ethernet communication network (e.g., an Ethernet Ring, etc.).

Additionally, while illustrated as a single system, it is to be understood that the computing device 1100 may be a distributed system. Thus, for instance, several devices may be in communication by way of a network connection and may collectively perform tasks described as being performed by the computing device 1100.

There is a number of example embodiments described herein.

Example 1 is a single-stage AC/DC Dual Active Bridge (DAB) converter having an AC/DC DAB converter circuit, with an AC/DC DAB topology having a primary side and a secondary side and a plurality of switches, to perform power transfer between the primary side and the secondary side, where the primary side is to receive or output an AC voltage and the secondary side is to output or receive a DC voltage, respectively, based on direction of the power transfer. The single-stage AC/DC Dual Active Bridge (DAB) converter also includes a switch control coupled to control the plurality of switches of the AC/DC DAB converter circuit by varying control variables that include phase shift φ, primary side duty cycle D1 and secondary side duty cycle D2, based on instantaneous current and power, to transition the converter circuit between a plurality of modes of operation, to satisfy zero voltage switching (ZVS) criterion that includes a ZVS current threshold.

Example 2 is the single-stage AC/DC DAB converter of example 1 that may optionally include that the ZVS criterion comprises a single current value threshold for each of primary side switches and second side switches.

Example 3 is the single-stage AC/DC DAB converter of example 1 that may optionally include that the AC/DC DAB converter circuit to is operable to vary the phase shift φ, the duty cycle D1 and the duty cycle D2 to increase range of ZVS while reducing switching power losses.

Example 4 is the single-stage AC/DC DAB converter of example 1 that may optionally include that the phase shift φ is defined as fundamental-frequency phase shift between voltages of the primary side and the secondary side and ranges from −0.25 to 0.25; the duty cycle D1 is defined as ratio of non-negative voltage period to switching period for the primary side and ranges from 0% to 100%; and the duty cycle D2 is defined as ratio of non-negative voltage period to switching period for the secondary side and ranges from 0% to 100%.

Example 5 is the single-stage AC/DC DAB converter of example 1 that may optionally include that the switching waveforms having a phase shift from a switching signal for a switch in a first leg of the primary side to a switching signal for a switch in a second leg of the primary side; the switching waveforms having the phase shift φ from a switching signal for a switch in the primary side to a switching signal for a switch in the secondary side; the switching waveforms having a phase shift from a switching signal for a switch in a third leg of the secondary side to a switching signal for a switch in a fourth leg of the secondary side; the phase shifts between the legs creating a three-step voltage function and corresponding step-wise current function in the single-stage AC/DC DAB converter; and the phase shift φ between the primary side and the secondary side defining power transfer of the single-stage AC/DC DAB converter.

Example 6 is the single-stage AC/DC DAB converter of example 1 that may optionally include that the switch control to operate in three schemes as the modes of operation depending on power level, transitioning between the schemes depending on a zero voltage switching condition.

Example 7 is the single-stage AC/DC DAB converter of example 1 that may optionally include that the switch control is operable in three schemes A, B, C, including: a Scheme A at a low-power, high-voltage condition with primary side switches switched at a threshold zero voltage switching condition and secondary side switches switched at a further threshold zero voltage switching condition and at a peak current condition; a Scheme B, with the primary side duty cycle D1 at 100% and the secondary side duty cycle D2 changing linearly with the phase shift; and a Scheme C at a high-power condition with the secondary side duty cycle D2 changing linearly with the phase shift.

Example 8 is the single-stage AC/DC DAB converter of example 1 that may optionally include that the switch control has a proportional integral (PI) controller to generate the phase shift φ using closed loop feedback of converter output compared to a variable reference.

Example 9 is the single-stage AC/DC DAB converter of example 1 that may optionally include that the switch control is operable to determine the duty cycle D1 and the duty cycle D2 based on the phase shift φ, a primary side voltage and a secondary side voltage.

Example 10 is a method of operating a single-stage AC/DC Dual Active Bridge (DAB) converter, including: varying, with a controller, control variables that include phase shift q, primary side duty cycle D1 and secondary side duty cycle D2, based on instantaneous current and power, to transition the single-stage AC/DC Dual Active Bridge (DAB) converter between a plurality of modes of operation, to satisfy zero voltage switching (ZVS) criterion that includes a ZVS current threshold, generating switching waveforms based on the phase shift φ, the primary side duty cycle D1 and the secondary side duty cycle D2 to control the plurality of switches of the AC/DC DAB converter circuit; and transferring power between a primary side and a secondary side with an AC/DC DAB converter circuit, with an AC/DC DAB topology having a primary side and a secondary side and a plurality of switches, to perform power transfer between the primary side to the secondary side, while satisfying zero voltage switching (ZVS) criterion that includes a ZVS current threshold, the primary side to receive or output an AC voltage and the secondary side to output or receive a DC voltage, respectively, when transferring power based on direction of the power transfer.

Example 11 is the method of example 10 that may optionally include that the phase shift φ is defined as fundamental-frequency phase shift between voltages of the primary side and the secondary side and ranges from −0.25 to 0.25; the duty cycle D1 is defined as ratio of non-negative voltage period to switching period for the primary side and ranges from 0% to 100%; and the duty cycle D2 is defined as ratio of non-negative voltage period to switching period for the secondary side and ranges from 0% to 100%.

Example 12 is the method of example 10 that may optionally include that the switching waveforms have a phase shift from a switching signal for a switch in a first leg of the primary side to a switching signal for a switch in a second leg of the primary side; the switching waveforms have the phase shift φ from a switching signal for a switch in the primary side to a switching signal for a switch in the secondary side; the switching waveforms have a phase shift from a switching signal for a switch in a third leg of the secondary side to a switching signal for a switch in a fourth leg of the secondary side; the phase shifts between the legs create a three-step voltage function and corresponding step-wise current function in the single-stage AC/DC DAB converter; and the phase shift φ between the primary side and the secondary side defines power transfer of the single-stage AC/DC DAB converter.

Example 13 is the method of example 10 that may optionally include that determining the phase shift φ, the primary side duty cycle D1 and the secondary side duty cycle D2 and the generating the switching waveforms are for the switch control are to operate in three schemes as operation modes depending on power level, transitioning between the schemes depending on a zero voltage switching condition.

Example 14 is the method of example 10 that may optionally include operating the switch control in three schemes A, B, C as the modes of operation, comprising: a Scheme A at a low-power, high-voltage condition with primary side switches switched at a threshold zero voltage switching condition and secondary side switches switched at a further threshold zero voltage switching condition and at a peak current condition; a Scheme B, with the primary side duty cycle D1 at 100% and the secondary side duty cycle D2 changing linearly with the phase shift φ; and a Scheme C at a high-power condition with the secondary side duty cycle D2 changing linearly with the phase shift φ.

Example 15 is the method of example 10 that may optionally include generating, through a proportional integral (PI) controller of the switch control, the phase shift φ using closed loop feedback of converter output compared to a variable reference.

Example 16 is the method of example 10 that may optionally include determining, through the switch control, the duty cycle D1 and the duty cycle D2 based on the phase shift φ, a primary side voltage and a secondary side voltage.

Example 17 is motor vehicle including: a battery; and an on-board charger having a single-stage AC/DC Dual Active Bridge (DAB) converter comprising an AC/DC DAB converter circuit, with an AC/DC DAB topology having a primary side and a secondary side and a plurality of switches, to perform power transfer between the primary side and the secondary side, the primary side to receive or output an AC voltage and the secondary side to output or receive a DC voltage, respectively, based on direction of the power transfer; and a switch control coupled to control the plurality of switches of the AC/DC DAB converter circuit by varying control variables that include phase shift, primary side duty cycle D1 and secondary side duty cycle D2, based on instantaneous current and power, to transition the converter circuit between a plurality of modes of operation, to satisfy zero voltage switching (ZVS) criterion that includes a ZVS current threshold.

Example 18 is the motor vehicle of example 17 that may optionally include that the ZVS criterion comprises a single current value threshold for each of primary side switches and second side switches.

Example 19 is the motor vehicle of example 17 that may optionally include that the AC/DC DAB converter circuit to is operable to vary the phase shift φ, the duty cycle D1 and the duty cycle D2 to increase range of ZVS while reducing switching power losses.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A single-stage AC/DC Dual Active Bridge (DAB) converter comprising:
an AC/DC DAB converter circuit, with an AC/DC DAB topology having a primary side and a secondary side and a plurality of switches, to perform power transfer between the primary side and the secondary side, the primary side to receive or output an AC voltage and the secondary side to output or receive a DC voltage, respectively, based on direction of the power transfer;
a switch control coupled to control the plurality of switches of the AC/DC DAB converter circuit by varying control variables that include phase shift φ, primary side duty cycle D1 and secondary side duty cycle D2, based on instantaneous current and power, to transition the converter circuit between a plurality of modes of operation, to satisfy zero voltage switching (ZVS) criterion that includes a ZVS current threshold.

2. The single-stage AC/DC DAB converter of claim 1, wherein the ZVS criterion comprises a single current value threshold for each of primary side switches and second side switches.

3. The single-stage AC/DC DAB converter of claim 1 wherein the AC/DC DAB converter circuit to is operable to vary the phase shift φ, the duty cycle D1 and the duty cycle D2 to increase range of ZVS while reducing switching power losses.

4. The single-stage AC/DC DAB converter of claim 1, wherein:
the phase shift φ is defined as fundamental-frequency phase shift between voltages of the primary side and the secondary side and ranges from −0.25 to 0.25;
the duty cycle D1 is defined as ratio of non-negative voltage period to switching period for the primary side and ranges from 0% to 100%; and
the duty cycle D2 is defined as ratio of non-negative voltage period to switching period for the secondary side and ranges from 0% to 100%.

5. The single-stage AC/DC DAB converter of claim 1, wherein:
the switching waveforms having a phase shift from a switching signal for a switch in a first leg of the primary side to a switching signal for a switch in a second leg of the primary side;
the switching waveforms having the phase shift φ from a switching signal for a switch in the primary side to a switching signal for a switch in the secondary side;
the switching waveforms having a phase shift from a switching signal for a switch in a third leg of the secondary side to a switching signal for a switch in a fourth leg of the secondary side;
the phase shifts between the legs creating a three-step voltage function and corresponding step-wise current function in the single-stage AC/DC DAB converter; and
the phase shift φ between the primary side and the secondary side defining power transfer of the single-stage AC/DC DAB converter.

6. The single-stage AC/DC DAB converter of claim 1, wherein:
the switch control to operate in three schemes as the modes of operation depending on power level, transitioning between the schemes depending on a zero voltage switching condition.

7. The single-stage AC/DC DAB converter of claim 1, wherein:
the switch control is operable in three schemes A, B, C, comprising:
a Scheme A at a low-power, high-voltage condition with primary side switches switched at a threshold zero voltage switching condition and secondary side switches switched at a further threshold zero voltage switching condition and at a peak current condition;
a Scheme B, with the primary side duty cycle D1 at 100% and the secondary side duty cycle D2 changing linearly with the phase shift φ; and
a Scheme C at a high-power condition with the secondary side duty cycle D2 changing linearly with the phase shift φ.

8. The single-stage AC/DC DAB converter of claim 1, wherein:
the switch control has a proportional integral (PI) controller to generate the phase shift φ using closed loop feedback of converter output compared to a variable reference.

9. The single-stage AC/DC DAB converter of claim 1, wherein:
the switch control is operable to determine the duty cycle D1 and the duty cycle D2 based on the phase shift φ, a primary side voltage and a secondary side voltage.

10. A method of operating a single-stage AC/DC Dual Active Bridge (DAB) converter, comprising:
varying, with a controller, control variables that include phase shift φ, primary side duty cycle D1 and secondary side duty cycle D2, based on instantaneous current and power, to transition the single-stage AC/DC Dual Active Bridge (DAB) converter between a plurality of modes of operation, to satisfy zero voltage switching (ZVS) criterion that includes a ZVS current threshold,
generating switching waveforms based on the phase shift φ, the primary side duty cycle D1 and the secondary side duty cycle D2 to control the plurality of switches of the AC/DC DAB converter circuit; and
transferring power between a primary side and a secondary side with an AC/DC DAB converter circuit, with an AC/DC DAB topology having a primary side and a secondary side and a plurality of switches, to perform power transfer between the primary side to the secondary side, while satisfying zero voltage switching (ZVS) criterion that includes a ZVS current threshold, the primary side to receive or output an AC voltage and the secondary side to output or receive a DC voltage, respectively, when transferring power based on direction of the power transfer.

11. The method of operating the single-stage AC/DC DAB converter of claim 10, wherein:
the phase shift φ is defined as fundamental-frequency phase shift between voltages of the primary side and the secondary side and ranges from −0.25 to 0.25;
the duty cycle D1 is defined as ratio of non-negative voltage period to switching period for the primary side and ranges from 0% to 100%; and
the duty cycle D2 is defined as ratio of non-negative voltage period to switching period for the secondary side and ranges from 0% to 100%.

12. The method of operating the single-stage AC/DC DAB converter of claim 10, wherein:
the switching waveforms have a phase shift from a switching signal for a switch in a first leg of the primary side to a switching signal for a switch in a second leg of the primary side;
the switching waveforms have the phase shift φ from a switching signal for a switch in the primary side to a switching signal for a switch in the secondary side;
the switching waveforms have a phase shift from a switching signal for a switch in a third leg of the secondary side to a switching signal for a switch in a fourth leg of the secondary side;
the phase shifts between the legs create a three-step voltage function and corresponding step-wise current function in the single-stage AC/DC DAB converter; and
the phase shift φ between the primary side and the secondary side defines power transfer of the single-stage AC/DC DAB converter.

13. The method of operating the single-stage AC/DC DAB converter of claim 10, wherein determining the phase shift φ, the primary side duty cycle D1 and the secondary side duty cycle D2 and the generating the switching waveforms are for the switch control are to operate in three schemes as operation modes depending on power level, transitioning between the schemes depending on a zero voltage switching condition.

14. The method of operating the single-stage AC/DC DAB converter of claim 10, further comprising:
operating the switch control in three schemes A, B, C as the modes of operation, comprising:
a Scheme A at a low-power, high-voltage condition with primary side switches switched at a threshold zero voltage switching condition and secondary side switches switched at a further threshold zero voltage switching condition and at a peak current condition;
a Scheme B, with the primary side duty cycle D1 at 100% and the secondary side duty cycle D2 changing linearly with the phase shift φ; and
a Scheme C at a high-power condition with the secondary side duty cycle D2 changing linearly with the phase shift φ.

15. The method of operating the single-stage AC/DC DAB converter of claim 10, further comprising generating, through a proportional integral (PI) controller of the switch control, the phase shift φ using closed loop feedback of converter output compared to a variable reference.

16. The method of operating the single-stage AC/DC DAB converter of claim 10, further comprising determining, through the switch control, the duty cycle D1 and the duty cycle D2 based on the phase shift φ, a primary side voltage and a secondary side voltage.

17. A motor vehicle comprising:
a battery; and
an on-board charger having a single-stage AC/DC Dual Active Bridge (DAB) converter comprising
an AC/DC DAB converter circuit, with an AC/DC DAB topology having a primary side and a secondary side and a plurality of switches, to perform power transfer between the primary side and the secondary side, the primary side to receive or output an AC voltage and the secondary side to output or receive a DC voltage, respectively, based on direction of the power transfer;
a switch control coupled to control the plurality of switches of the AC/DC DAB converter circuit by varying control variables that include phase shift φ, primary side duty cycle D1 and secondary side duty cycle D2, based on instantaneous current and power, to transition the converter circuit between a plurality of modes of operation, to satisfy zero voltage switching (ZVS) criterion that includes a ZVS current threshold.

18. The motor vehicle of claim 17, wherein the ZVS criterion comprises a single current value threshold for each of primary side switches and second side switches.

19. The motor vehicle of claim 17 wherein the AC/DC DAB converter circuit to is operable to vary the phase shift φ, the duty cycle D1 and the duty cycle D2 to increase range of ZVS while reducing switching power losses.
